(19) United States
(12) Patent Application Publication
(10) Pub. No.: US 2015/0299402 A1
(43) Pub. Date: Oct. 22, 2015

(54) PROCESS FOR PREPARING A FLUOROPOLYMER COMPOSITION

(71) Applicant: E I DU PONT DE NEMOURS AND COMPANY, Wilmington, DE (US)

(72) Inventors: RALPH MUNSON ATEN, CHADDS FORD, PA (US); HEIDI ELIZABETH BURCH, BEAR, DE (US)

(21) Appl. No.: 14/377,651

(22) PCT Filed: Feb. 6, 2013
(86) PCT No.: PCT/US13/24861

§ 371 Date: Aug. 8, 2014

Related U.S. Application Data
(60) Provisional application No. 61/596,403, filed on Feb. 8, 2012.

(51) Int. Cl. C08J 3/16

(52) U.S. Cl. CPC C08J 3/16; C08J 2327/18; C08J 2329/10

(57) ABSTRACT

A process is provided for preparing a fluoropolymer composition. The process involves: i) combining an aqueous dispersion of melt flowable polytetrafluoroethylene and an aqueous dispersion of melt-fabricable tetrafluoroethylene/perfluoro(alkyl vinyl ether) copolymer to form a fluoropolymer aqueous dispersion, ii) coagulating the fluoropolymer aqueous dispersion to form a solid fluoropolymer phase and an aqueous phase, iii) separating the solid fluoropolymer phase from the aqueous phase to form coagulated fluoropolymer, and iv) heating the coagulated fluoropolymer at a temperature of from 280° C. to less than the highest melting point of the coagulated fluoropolymer for a period of time sufficient to increase the tensile modulus, increase the tensile strength, increase the MIT flex life, and decrease the melt flow rate of the coagulated fluoropolymer and thereby forming the fluoropolymer composition.

### FIELD OF THE INVENTION

The present invention relates to a process for preparing a composition having improved physical properties from melt flowable polytetrafluoroethylene and melt-fabricable tetrafluoroethylene/perfluoro(alkyl vinyl ether).

### BACKGROUND OF THE INVENTION

“Continuous use temperature” of a perfluoropolymer is the highest temperature at which the perfluoropolymer can be used for an extended period of time while still retaining substantial strength, The length of time is 6 months and the retention of a tensile property, such as, for example, Young's modulus, tensile strength or elongation at break, means that the loss in this property is a maximum of 50% as compared to the property prior to exposure to the continuous use heating. The tensile testing of the perfluoropolymer is done by removal of perfluoropolymer test samples from an oven heated to the test temperature and then carrying out the tensile property measurements at ambient temperature after the sample has cooled to ambient temperature.

For tetrafluoroethylene/perfluoro(alkyl vinyl ether) copolymer (PFA), the upper service temperature is 260° C., which is far less than the 300° C. to 314° C. melting point of PFA. The melting point is the temperature corresponding to the endothermic peak resulting from the phase change of the PFA from the solid to the liquid state during the first heating phase in differential scanning calorimetry (DSC). The temperature that can be withstood by the PFA is far less than its melting point, however, as indicated by the much lower upper service temperature.

The reduction in tensile property with prolonged heating can indicate a deterioration of the integrity of the PFA. The problem is how to improve the integrity of PFA so that it can be used at a temperature greater than its current upper service temperature.

### SUMMARY OF THE INVENTION

Briefly stated, and in accordance with one aspect of the present invention solving this problem, there is provided a process for preparing a fluoropolymer composition comprising:

i) combining an aqueous dispersion of melt flowable polytetrafluoroethylene (MFPTFE) and an aqueous dispersion of melt-fabricable tetrafluoroethylene/perfluoro(alkyl vinyl ether) copolymer (PFA) to form a fluoropolymer aqueous dispersion,

ii) coagulating the fluoropolymer aqueous dispersion to form a solid fluoropolymer phase and an aqueous phase,

iii) separating the solid fluoropolymer phase from the aqueous phase to form coagulated fluoropolymer, and

iv) heating the coagulated fluoropolymer at a temperature of from 280° C. to less than the highest melting point of the coagulated fluoropolymer for a period of time sufficient to increase the tensile modulus, increase the tensile strength, increase the MIT flex life, and decrease the melt flow rate of the coagulated fluoropolymer and thereby forming the fluoropolymer composition.

Surprisingly, in the present process, presence of the MFPTFE improves the integrity of the composition resulting from heat aging, enabling the resultant fluoropolymer composition to exhibit an upper service temperature greater than 260° C.

The present process provides benefits that manifest themselves in the capability of the resultant fluoropolymer composition or fluoropolymer article fabricated therefrom being used in high-temperature service for an extended period of time, for example, at least 6 months, such as at temperatures of 280° C. and above, preferably at least 290° C., and most preferably at least 300° C., the fluoropolymer composition or fluoropolymer article made therefrom exhibiting the improved physical properties described above.

In one embodiment, the process further comprises melt mixing the coagulated fluoropolymer prior to the heating step (iv) to form melt mixed fluoropolymer, cooling and solidifying the melt mixed fluoropolymer and thereafter subjecting the melt mixed fluoropolymer in the solid state to the heating step (iv).

In one embodiment, the process further comprises melt mixing the coagulated fluoropolymer prior to the heating step (iv) to form melt mixed fluoropolymer, melt fabricating the melt mixed fluoropolymer into a fluoropolymer article, cooling and solidifying the fluoropolymer article, and thereafter subjecting the fluoropolymer article in the solid state to the heating step (iv).

In accordance with another aspect of the present invention, there is provided a fluoropolymer composition comprising melt flowable polytetrafluoroethylene and melt-fabricable tetrafluoroethylene/perfluoro(alkyl vinyl ether) copolymer, the fluoropolymer composition having two first melt melting points, one at 316±1° C. and another at 328±1° C.

### DETAILED DESCRIPTION

The melt flowable polytetrafluoroethylene (MFPTFE) used in the present process is tetrafluoroethylene (TFE) homopolymer or a modified polytetrafluoroethylene containing a small amount, not more than about 1% by weight based on the weight of all repeating units in the polymer, of a monomer co-polymerizable with TFE, such as hexafluoropropylene, perfluoro(alkyl vinyl ether), fluoroalkylethylene, or chlorotrifluoroethylene, and is flowable when in the molten state (melt flowable). Such MFPTFE is commonly known as “polytetrafluoroethylene micropowder” or “polytetrafluoroethylene wax” and is described in “Encyclopedia of Polymer Science and Engineering”, volume 16, pp. 597-598, John Wiley & Sons, 1989. MFPTFE can be prepared by aqueous dispersion polymerization of tetrafluoroethylene in the presence of a chain transfer agent. Manufacture of such MFPTFE is known from U.S. Pat. No. 3,067,262 and U.S. Pat. No. 6,060,167. The MFPTFE used in the present process can be further characterized by having a heat of crystallization of at least 50 J/g as determined by differential scanning calorimetry, for example as reported in U.S. Pat. No. 5,473,©18, column 5, lines 35-57. The MFPTFE used in the present process can be further characterized by its crystalline melting point of from 320° C. to 335° C. The MFPTFE used in the present process can be further characterized by its melt flow rate (MFR) as measured in accordance with ASTM 11238 at 372° C. using a 5 kg weight. All melt flow rates disclosed herein are determined on polymer prior to the heating step (iv), unless otherwise indicated. In one embodiment the MFR of the MFPTFE is from 0.01 g/10 min to 1,000 g/10 min. In another embodiment the MFR of the MFPTFE is from 0.1 g/10 min to 100 g/10 min. In another embodiment the MFR of the MFPTFE is from 1 g/10 min to 50 g/10 min. In another embodiment the MFR of the MFPTFE is from 10 g/10 min to 20 g/10 min. The MFR of the PFA and MFPTFE components used in the present process are preferably within the range of 20 g/10 min MFR units from one other, preferably 15 g/10 min and more preferably 10 g/10 min MFR units from one other.

While the MFPTFE has low molecular weight, it nevertheless has sufficient molecular weight to be solid up to high temperatures, e.g. at least 300° C., more preferably at least 310° C., even more preferably, at least 320° C. Preferably, the MFPTFE has a higher melting point than the melting point of the PFA, preferably at least 5° C. higher.

E. I. du Pont de Nemours and Company sells MFPTFE as ZONYL® fluoroadditive. Example commercial MFPTFE products include Zonyl® MP1600N powder, and Zonyl® PTFE TE3887N colloid.

The melt-fabricable tetrafluoroethyleneiperfluoro(alkyl vinyl ether) (PFA) copolymer used in the present process is a fluoroplastic copolymer of tetrafluoroethylene (TFE) and perfluoro(alkyl vinyl ether) (PAVE) in which the perfluoroalkyl group, linear or branched, contains 1 to 5 carbon atoms. Preferred PAVE monomers are those in which the perfluoroalkyl group contains 1, 2, 3 or 4 carbon atoms, respectively known as perfluoro(rnethyl vinyl ether) (PMVE), perfluoro(ethyl vinyl ether) (PEVE), perfluoro(propyl vinyl ether) (PPVE), and perfluoro(butyl vinyl ether) (PBVE). The copolymer can be made using several PAVE monomers, such as the TFE/PMVE/PPVE terpolymer. The PFA may contain about 1-15 wt % PAVE, although PAVE content of 2 to 5 wt %, preferably 3.0 to 4,8 wt %, is the most common PAVE content when a single PAVE monomer is used to form the PFA, the TFE comprising the remaining repeat units in the copolymer, When PAVE includes PMVE, the composition is about 0.5-13 wt % perfluoro(methyl vinyl ether) and about 0.5 to 3 wt % PPVE, with TFE comprising the remaining repeat units in the copolymer. Preferably, the identity and amount of PAVE present in the PFA is such that the melting point of the PFA is greater than 300° C. In one embodiment, the melting point of the PFA is in the range of 300° C. to 314° C. The PFAs used in the process of the present invention are those that are melt flowable so as to enable them to be melt fabricable. By melt fabricable is meant that the PFA is sufficiently flowable in the molten state that it can be fabricated by melt processing such as extrusion, to produce products having sufficient strength so as to be useful. This sufficient strength may be characterized by the PFA by itself exhibiting an MIT Flex Life of at least 1,000 cycles, preferably at least 2,000 cycles using 8 mil (0.21 mm) thick film. In the MIT Flex Life test, the film is gripped between jaws and is flexed back and forth over a 135 range. In this case, the strength of the PFA is indicated by it not being brittle. The PFA used in the process of the present invention is a fluoroplastic, not a fluoroelastomer. As a fluoroplastic, the PFA is semicrystalline, also called partially crystalline. The melt flow rate (MFR) of the PFA is (prior to the heating step (iv)) at least 0.1 g/10 min, preferably at least 5 g/10 min, more preferably at least 6 or 7 g/10 min and no greater than 50 g/10 min, as measured using the extrusion plastometer described ASTM D-1238 under the conditions disclosed in ASTM D 3307, namely at a melt temperature of 372° C. and under a load of 5 kg. In one embodiment the MFR of the PFA is from 0.01 g/10 min to 50 g/10 min. In another embodiment the MFR of the PFA is from 0.1 g/10 min to 40 g/10 min. In another embodiment the MFR of the PFA is from 1 g/10 min to 30 g/10 min. In another embodiment the MFR of the melt flowable PTFE is from 2 g/10 min to 15 g/10 min. The PFA is preferably as polymerized by aqueous dispersion polymerization. That is to say, the PFA has not been stabilized by subjecting to humid heat or fluorine treatment after polymerization to reduce the concentration of unstable ends that are produced as a result of the aqueous dispersion polymerization (e.g., carboxyl-based unstable ends such as —COF, —COOH). Examples of PFA are disclosed in U.S. Pat. No. 3,635,926 and U.S. Pat. No. 5,932,673.

The MFPTFE and PFA used in the present process are formed by conventional aqueous dispersion polymerization, for example, involving an aqueous phase, monomers, initiator and surfactant. Examples of initiators that can be used include ammonium persullate, potassium persulfate, bis(perfluoroalkane carboxylic acid) peroxide, azo compounds, a permanganate system, and disuccinic acid peroxide. Examples of surfactants used in aqueous dispersion polymerization include ammonium perfluorooctanoate and perfluoroalkyl ethane sulfonic acid salts, such as the ammonium salt. A conventional aqueous dispersion polymerization process for the manufacture of MFPTFE involves the steps of precharging an aqueous medium and surfactant to a stirred autoclave, deoxygenating, pressurizing with TFE to predetermined level, adding modifying comonomer if desired, agitating, bringing the system to desired temperature, e.g., 60-100° C., introducing initiator, adding more TFE according to predetermined basis, and regulating temperature and pressure. Initiator addition, at a fixed or variable rate, may continue throughout the batch or only for part of the batch. Recipe and operating parameters not fixed by the equipment are commonly selected in order that temperature is maintained approximately constant throughout the polymerization. This same general procedure is followed for polymerizing the monomers to make PFA, except that the polymerization temperature and order of addition of the TFE and the PAVE monomer will depend on the identity of the PAVE. In the manufacture of PFA, PAVE monomer and chain transfer agent are optionally added to the autoclave before the initial charge of TFE is added, and additional PAVE can be added throughout the duration of the batch. Examples of general procedures for making PFA aqueous dispersion are found in U.S. Pat. No. 5,932,673. Examples of general procedures for making MFPTFE aqueous dispersion are found in U.S. Pat. No. 6,060,167.

The submicrometer particle size of the polymer particles in the aqueous dispersion of MFPTFE and aqueous dispersion of PFA is small enough that the particles remain dispersed in the aqueous polymerization medium until the polymerization reaction is completed. Typically, the average as-polymerized polymer particle diameter in the aqueous dispersions will be one micrometer or less as determined by the laser light scattering method of ASTM 04464. In one embodiment, the average as-polymerized polymer particle size is in the range of 0.1 to 0.5 micrometer. In another embodiment, the average as-polymerized polymer particle size is in the range of 0.1 to 0.3 micrometer. In another embodiment, the average as-polymerized polymer particle size is in the range of 0.1 to 0.25 micrometer. in another embodiment, the average as-polymerized polymer particle size is in the range of 0.1 to 0.2 micrometer. These particle sizes apply to the aqueous dispersion of MFPTFE and the aqueous dispersion of PFA combined in the present process to form the fluoropolymer aqueous dispersion. The smaller the average polymer particle size, the more stable the aqueous dispersion of the polymer particles, enabling the polymerization to be carried out to higher polymer solids content before stopping the polymerization and carrying out the coagulation step.

The proportions of MFPTFE and PFA used in the present process to make fluoropolymer compositions will contain at least 15 wt %, preferably at least 18 wt %, and more preferably at least 20 wt % of MFPTFE on a dry basis. The maximum amount of MFPTFE will be less than 50 wt % on a dry basis. For all the MFPTFE minimum contents mentioned above, the more preferred maximum amount of MFPTFE in the composition forming the component is 45 wt %, thereby defining MFPTFE content ranges of 15 to 45 wt % and 18 to 45 wt % on a dry basis. On the same basis, the preferred maximum amount of MFPTFE is 40 wt % and more preferably, 35 wt % and even more preferably 30 wt %, thereby defining such additional ranges as 18 to 40 wt %, 18 to 35 wt %, 18 to 30 wt %, 20 to 45 wt %, 20 to 35 wt %, and 20 to 30 wt % MFPTFE on a dry basis. For all these wt % amounts, the PFA constitutes the remaining polymer content to total 100 wt % based on the combined dry weight of MFPTFE and PFA. In one embodiment, a single MFPTFE and a single PFA is used to form the fluoropolymer composition, and these are the only polymers making up the fluoropolymer composition. In one embodiment, pigment which preferably does not render the fluoropolymer composition electrically conductive may be present. In one embodiment the dielectric constant of the fluoropolymer composition is no greater than 2.4, more preferably, no greater than 2.2, determined at 20° C., enabling the fluoropolymer composition and articles made therefrom to be electrically insulating, i.e. electrically non-conductive. In one embodiment, the fluoropolymer composition and articles made therefrom are free of electrically conductive carbon.

The present process involves the step of combining an aqueous dispersion of MFPTFE and an aqueous dispersion of PFA to form a combined MFPTFE and PFA fluoropolymer aqueous dispersion. Combining is accomplished by bringing the two separate aqueous dispersions into contact with one another accompanied by mixing. High-speed stirring, pumping, or any other vigorous agitation must be avoided prior to combination of the MFPTFE and PFA aqueous dispersions to minimize sheared primary particles or premature coagulation of the primary particles and to minimize foaming. In one embodiment, the MFPTFE or PFA aqueous dispersion is conveyed by gravity from storage into a vessel containing the other dispersion followed by gentle agitation to thoroughly mix the two dispersions and thereby form the fluoropolymer aqueous dispersion. In one embodiment, the separately prepared aqueous dispersions of MFPTFE and PFA components are mixed together to obtain the fluoropolymer aqueous dispersion as a mixture of the submicrometer-size primary polymer particles in aqueous dispersion form.

The present process involves the step of coagulating the fluoropolymer aqueous dispersion to form a solid fluoropolymer phase and an aqueous phase. The coagulation step is carried out by conventional means for coagulation of aqueous dispersions of perfluoropolymers. In one embodiment, coagulation is carried out by the conventional method of application of agitation or shearing force to the fluoropolymer aqueous dispersion. In another embodiment, coagulation is carried out by the conventional method of addition of an electrolyte to the fluoropolymer aqueous dispersion, optionally with agitation. In another embodiment, coagulation is carried out by the conventional method of freeze/thaw. The as-polymerized polymer particle sizes described in the aqueous dispersions above are the primary particles (sizes) of each polymer. Coagulation of the MFPTFE and PFA primary particles in the fluoropolymer aqueous dispersion causes these particles to agglomerate together forming coagulated fluoropolymer, which upon separation and drying becomes a fine powder mixture of these polymer primary particles, the coagulated fluoropolymer having an average particle size depending on the method of coagulation, but of at least about 200 micrometers, as determined by the dry-sieve analysis disclosed in U.S. Pat. No. 4,722,122. The agglomerates of primary particles and thus the particles of the coagulated fluoropolymer fine powder are often referred as secondary particles. The coagulation step is a co-coagulation of the fluoropolymer aqueous dispersion which comprises a mixture of aqueous dispersion of MFPTFE and aqueous dispersion of PFA and results in coagulated fluoropolymer particles comprising agglomerates of the primary particles of MFPTFE and PFA.

The present process involves the step of separating the solid fluoropolymer phase from the aqueous phase to obtain the coagulated fluoropolymer. The solid fluoropolymer phase can be separated from the aqueous phase by decanting, with or without filtration. In one embodiment, the separating step further includes removal of water from the coagulated fluoropolymer by drying at a temperature below the lowest melting point of the coagulated fluoropolymer to form the coagulated fluoropolymer comprising a fine powder of secondary particles. For example, the decanted or filtered coagulated fluoropolymer can be dried at 150° C. for a period of up to three days before it is subjected to the heating step (iv).

In one embodiment, prior to the heating step (iv), the present process further nvolves the steps of melt mixing the coagulated fluoropolymer to form melt mixed fluoropolymer, cooling and solidifying the melt mixed fluoropolymer and thereafter subjecting the melt mixed fluoropolymer in the solid state to the heating step (iv). Melt-mixing is the heating of the coagulated fluoropolymer above the melting point of both PFA and MFPTFE, and subjecting the resultant melt to mixing, such as by stirring the melt, as occurs using the injection or extrusion screw present in injection molding or extrusion, respectively, followed by cooling and solidification to form the melt mixed fluoropolymer in the solid state. The shear rate used for the melt mixing will generally be at least about 75 s⁻¹. The melt mixability of the coagulated fluoropolymer indicates that it is melt flowable, and the amount of PFA present in the fluoropolymer composition is effective to also make it melt-fabricable.

In the embodiment where the melt mixed fluoropolymer is subjected to melt extrusion, involving melt blending of the mixture, the melt mixed fluoropolymer is formed into pellets as an intermediate molded article for further melt fabrication, and subsequently, the heating step (iv). In one embodiment, the first exposure of the coagulated fluoropolymer to heat can be the melt mixing and melt fabrication steps to form the fluoropolymer article, such as extruded wire insulation, cable jacket, or injection molded article. In either case, the melt mixing involves the formation of a molten mass of polymer and mixing this mass together as part of the melting process. Typically, this melt mixing is carried out at a temperature above the melting point of the MFPTFE, and thus above the melting point of the PFA, whether the melting point of the MFPTFE is the first heat melt point (about 343° C.) or second heat melt point (about 327° C.) of the MFPTFE, e.g. melt mixing at a temperature of at least 350° C. The melt mixed fluoropolymer becomes a dispersion of the MFPTFE component in a continuous phase of the PFA component, and this dispersion relationship is carried over into the fluoropolymer article molded from the melt mixed fluoropolymer, and if the molded fluoropolymer article is pellets, then into the final fluoropolymer article melt fabricated from such pellets.

In one embodiment, prior to the heating step (iv), the present process further involves the steps of melt mixing the coagulated fluoropolymer to form melt mixed fluoropolymer, optionally cooling and solidifying the melt mixed fluoropolymer, melt fabricating the melt mixed fluoropolymer into a fluoropolymer article, cooling and solidifying the fluoropolymer article, and thereafter subjecting the fluoropolymer article in the solid state to the heating step (iv). The melt fabrication of the melt mixed fluoropolymer can be carried out by conventional processes used to melt fabricate fluoropolymers, such as extrusion, injection molding, blow molding, and transfer molding. The extrusion process is carried out on the melt mixed fluoropolymer heated above its melting point, whereby this process is melt extrusion.

In one embodiment, the melt fabricating step involves shearing the molten fluoropolymer, as occurs in each of the aforementioned melt fabrication processes. The rate at which the fluoropolymer melt is sheared depends on the melt fabrication process. For example, extrusion of tubing of the molten fluoropolymer can be practiced at shear rate as low as 1 sec⁻¹. The same is true for extrusion of molten fluoropolymer for thick wire insulations and transfer molding. Extrusion of molten fluoropolymer as thin wire insulation and injection molding of molten fluoropolymer will generally involve subjecting the fluoropolymer melt to a shear rate of at least 50 sec⁻¹, or at least 75 sec⁻¹, or at least 100 sec⁻¹. The shear rate for injection molding can reach 1,000 sec⁻¹ and higher, Thus, the shear rate for these melt fabrication processes, all of which involve forcing molten fluoropolymer through an orifice, is at least 1 sec⁻¹ and can reach 1,000 sec⁻¹ or higher. Depending on the melt fabrication process and the final shape of the article being fabricated, the minimum shear rate to which the molten fluoropolymer is subjected can be at least 10 sec⁻¹, or at least 20 sec⁻¹, at least 30 sec⁻¹ or at least 40 sec⁻¹, or any of the shear rates mentioned above. The melt fabrication can be compression molding, which involves pressing molten fluoropolymer in a mold, whereby there is no orifice through which the molten fluoropolymer is forced, whereby there is minimal to no shear of the molten fluoropolymer. This absence of shear in the compression molding process can be quantified as a shear rate of less than 0.1 sec⁻¹.

Examples of fluoropolymer articles that can be made by the melt fabrication step include linings for the following: vessels, chemical columns, pipes, fittings, pumps, and valves. In these applications the lining is supported by the structure forming the equipment being lined. The fluoropolymer article made by the present process can be unsupported if made to have sufficient wall thickness or mass as to have the required integrity for the application. Instead of linings, the fluoropolymer article can form the entire equipment. Additional fluoropolymer articles can be heat exchanger tubes and other heat exchanger elements, such as tube sheet and/or housing, hoses and expansion joints, seals and gaskets, Self-supporting fluoropolymer articles can be made, such as baskets and carriers used for example in semiconductor manufacture. The present process can be used to form fluoropolymer compositions useful as primary and/or secondary electrical insulation for communications cable used in high temperature applications such as downhole wells for extraction of hot fluid, such as oil (liquid), gas, or steam from the earth and for high temperature-resistant motor windings for motors used in such high temperature applications. in most of these applications, the heating step (iv) of the fluoropolymer article is done by the hot fluid coming into direct or proximate contact with the fluoropolymer article.

The time of high temperature exposure of the fluoropolymer article made by the present process will depend on the application. The fluoropolymer article can be exposed during the heating step (iv) to the different temperatures disclosed herein, which are greater than the upper service temperature of the PFA by itself, for at least one day, preferably at least 1 week, more preferably at least two weeks, and still more preferably at least 6 months.

The present process involves the step of heating the coagulated fluoropolymer at a temperature of from 280° C. to less than the highest melting point of the coagulated fluoropolymer. In one embodiment, prior to the heating step (iv), the coagulated fluoropolymer is melt mixed to form melt mixed fluoropolymer, cooled and solidified followed by subjecting the melt mixed fluoropolymer in the solid state to the heating step (iv). In one embodiment, prior to the heating step (iv), the coagulated fluoropolymer is melt mixed to form melt mixed fluoropolymer, the melt mixed fluoropolymer is melt fabricating into a fluoropolymer article, which is then cooled and solidified to form a solid fluoropolymer article, and thereafter the fluoropolymer article in the solid state is subjected to the heating step (iv). Thus, the heating step (iv) can be carried out on the coagulated fluoropolymer, melt mixed fluoropolymer arising from the coagulated fluoropolymer, or the fluoropolymer article arising from the coagulated fluoropolymer.

In one embodiment, the duration of the heating step (iv) is at least 4 hours. In another embodiment, the duration of the heating step (iv) is at least 12 hours. In another embodiment, the duration of the heating step (iv) is at least 24 hours. In another embodiment, the duration of the heating step (iv) is at least 3 days. In another embodiment, the duration of the heating step (v) is at least 7 days. In another embodiment, the duration of the heating step (iv) is at least 14 days. In another embodiment, wherein the fluoropolymer composition is subjected to continuous service at high temperature, the duration of the heating step (iv) is at least 6 months.

The duration of the heating step (iv) can be the result of continuous or discontinuous heating. In one embodiment, heating is continuous, and the heating step (iv) is uninterrupted. In one embodiment, the heating is discontinuous, and the heating step (iv) is interrupted, as may occur when a fluoropolymer article is used in the depths of a downhole well and is periodically removed and re-installed in the well. Thus, the duration of the heating step (iv) is a cumulative time of exposure to heating whether continuous or discontinuous.

The lower limit of the temperature of the fluoropolymer during the heating step (iv) is 280° C. The upper limit of the temperature of the fluoropolymer during the heating step (iv) is bounded by the highest me ting point of the fluoropolymer. MFPTFE is the higher melting point material in the fluoropolymer composition comprising PFA and MFPTFE, typically having a melting point of 330° C. or less. Thus the highest melting point the fluoropolymer composition can have is less than 330° C. In practice, the highest melting point of the fluoropolymer composition is less than the melting point of the MFPTFE. Thus, the heating step (iv) is carried out at a temperature of from 280° C. to less than 330° C. In one embodiment, the heating step (iv) is carried out at from 280° C. to less than 330° C. In another embodiment, the heating step (iv) is carried out at from 285° C. to less than 330° C. In another embodiment, the heating step (iv) is carried out at from 290° C. to less than 330° C. In another embodiment, the heating step (iv) is carried out at from 295° C. to less than 330° C. In another embodiment, the heating step (iv) is carried out at from 300° C. to less than 330° C. In another embodiment, the heating step (iv) is carried out at from 305° C. to less than 330° C. In another embodiment, the heating step (iv) is carried out at from 310° C. to less than 330° C. In another embodiment, the heating step (iv) is carried out at from 315° C. to less than 330° C. In another embodiment, the heating step (iv) is carried out at from 320° C. to less than 330° C. In another embodiment, the heating step (iv) is carried out at from 325° C. to less than 330° C. In another embodiment, the heating step (iv) is carried out at about 330° C. In another embodiment, the heating step (iv) is carried out at least two temperatures selected from within the above ranges, e.g., for a duration of time at 290° C., followed by a duration of time at 310° C.

The heating step (iv) is carried out for any combination of duration of time and heating temperature described above which results in an increase in the tensile modulus, increase in the tensile strength, increase in the MIT flex life, and decrease in the melt flow rate of the fluoropolymer from those properties as measured on the fluoropolymer prior to the heating step (iv), i.e., those properties as measured on the coagulated fluoropolymer, melt mixed fluoropolymer derived from the coagulated fluoropolymer or fluoropolymer article derived from the coagulated fluoropolymer. The heating step (iv) carried out at higher temperatures within the ranges described will result in the fluoropolymer exhibiting the described physical property changes in a shorter period of time than if the heating step is carried out at lower temperatures within the ranges described.

In one embodiment, the heating step (iv) is carried out at a temperature of at least 300° C. and for a time period of at least 7 days, and the fluoropolymer following the heating step (iv) exhibits at least one of the following: i) a tensile modulus measured at 25° C. at least 1.2 times greater than the tensile modulus of the fluoropolymer prior to the heating step, ii) a tensile strength measured at 25° C. at least 1.1 times greater than the tensile strength of the fluoropolymer prior to the heating step, and iii) a MIT flex life measured at 25° C. at least 100 times, preferably at least 120 times, greater than the MIT flex of the fluoropolymer prior to the heating step.

Prior to the heating step (iv), the fluoropolymer of the coagulated fluoropolymer, melt mixed fluoropolymer or fluoropolymer article exhibits two melting points, the first (Tm1) falling within the range of 300-314° C. (arising from the PFA, the exact melting point within this range depending on the specific PFA used), and the second (Tm2) falling within the range of 320-330° C. (arising from the MFPTFE, the exact melting point within this range depending on the specific MFPTFE used). In one embodiment, prior to the heating step (iv), the fluoropolymer of the coagulated fluoropolymer, melt mixed fluoropolymer or fluoropolymer article exhibits two melting points, Tm1 at 308±1° C. and Tm2 at 327±1° C.

In the embodiment where the heating step (iv) is carried out directly on the coagulated fluoropolymer (i.e., without melt mixing of the coagulated fluoropolymer), the resultant fluoropolymer composition has two melting points. The first melting point of the fluoropolymer composition in this embodiment (Tm1H) falls within the range of 304-318° C. and is at least 4° C. greater than the first melting point Tm1 of the coagulated fluoropolymer prior to the heating step (iv). In another embodiment, Tm1H is at least 6° C. greater than Tm1. In another embodiment, Tm1 H is at least 8° C. greater than Tm1. In another embodiment, Tm1H is at least 10° C. greater than Tm1. The second melting point of the resultant fluoropolymer composition in this embodiment (Tm2H) falls within the range of 321-330° C. and is at least 1° C. greater than the second melting point Tm2 of the coagulated fluoropolymer prior to the heating step (iv). In another embodiment, Tm2H is at least 2° C. greater than Tm2. In another embodiment, Tm2H is at least 3° C. greater than Tm2. In another embodiment, Tm2H is at least 4° C. greater than Tm2. In one embodiment where the heating step (iv) is carried out on the coagulated fluoropolymer, the resultant fluoropolymer composition has Tm1H of 316±1° C. and Tm2H of 328±1° C. In this embodiment, in addition to the beneficial properties already described, the heating step also results in an at least 4° C. increase in the lower of the two melting points exhibited by the fluoropolymer composition.

Thus, the present invention further includes a fluoropolymer composition comprising melt flowable polytetrafluoroethylene and melt-fabricable tetrafluoroethylene/perfluoro(alkyl vinyl ether) copolymer, the fluoropolymer composition having two melting points Tm1H and Tm2H, wherein Tm1H is greater than Tm1 as discussed above, and wherein Tm2H is greater than Tm2 as discussed above. In one embodiment, the fluoropolymer composition comprises melt flowable polytetrafluoroethylene and melt-fabricable tetrafluoroethylene/periluoro(alkyl vinyl ether) copolymer, the fluoropolymer composition having two melting points, Tm1H of 316±1° C. and Tm2H of 328±1° C.

In the embodiment further comprising melt mixing the coagulated fluoropolymer prior to the heating step (iv) to form melt mixed fluoropolymer, and thereafter subjecting the melt mixed fluoropolymer in the solid state to the heating step (iv), the resultant fluoropolymer composition has one melting point, the one melting point being greater than Tm1 of the coagulated fluoropolymer but less than Tm2 of the coagulated fluoropolymer. In one such embodiment, the coagulated fluoropolymer has two first heat melting points, one at 308±1° C. and another at 327±1° C., and the resultant fluoropolymer composition after melt mixing the coagulated fluoropolymer prior to the heating step (iv) to form melt mixed fluoropolymer, and thereafter subjecting the melt mixed fluoropolymer in the solid state to the heating step (iv), has one first heat melting point at 319±1° C.

Herein melting point refers to first heat melting point as determined by DSC.

### EXAMPLES

### Method—Differential Scanning Calorimetry (DSC)

The procedure for determining melting points disclosed herein is by differential scanning calorimeter analysis in accordance with ASTM 03418-08. The calorimeter used is a TA Instruments (New Castle, Del., USA) Q1000 model. The temperature scale has been calibrated using (a) 3 metal melting onsets: mercury (−38.86° C.), indium (156.61° C.), tin (231.93° C.) and (b) the 10°/min heating rate and 30 ml/min dry nitrogen flow rate. The calorimetric scale has been calibrated using the heat of fusion of indium (28.42 J/g) and the (b) conditions. The melting point determinations are carried out using the (b) conditions. The melting points disclosed herein are the endothermic peak melting point obtained from the first heating (melting) of the polymer following the schedule set forth in U.S. Pat. No. 5,603,999, except that the highest temperature used is 350° C. For the PFA the melting point is from the first heat. For the MFPTFE, the melting point is from the first heat.

### Method—Tensile Modulus

The tensile (Young's) modulus is determined by the procedure of ASTM D 638-03 as modified by ASTM 03307 section 9.6 on dumbbell-shaped test specimens 15 mm wide by 38 mm long and having a thickness of 5 mm, stamped out from 60 mil (1.5 mm) thick compression molded plaques. All tensile modulus values reported in these examples are measured at 23° C±2° C.

### Method—Tensile Strength

The tensile strength was measured according to ASTM D-1708 at 23° C.±2° C.

### MIT Flex Life

MIT Flex Life was measured according to ASTM D 2176 using an 8 mil (0.21 mm) thick compression molded film.

### Compression Molded Plaques and Film

The compression molding of the plaques and film used in the Tensile Modulus and MIT Flex Life tests was carried out on melt mixed compositions made in a Brabender® single screw extruder (equipped with a 1¼ in (3.2 cm) diameter screw having a Saxton-type mixing tip and the extruder has an L/D ratio of 20:1) under a force of 20,000 lbs (9070 kg) at a temperature of 343° C. to make 7×7 in (17.8×17.8 cm) compression moldings. In greater detail, to make the 60 mil (1.5 mm) thick plaque, 80 g of the composition is added to a chase which is 63 mil (1.6 mm) thick. The chase defines the 17.8×17.8 cm plaque size. To avoid sticking to the platens of the compression molding press, the chase and composition filling are sandwiched between two sheets of aluminum. The combination of the chase and the aluminum sheets (backed up by the platens of the press) form the mold. The press platens are heated to 343° C. The total press time is 10 min, with the first one minute being used to gradually reach the press force of 20,000 lbs (9070 kg) and the last minute being used for pressure release. The sandwich is then immediately transferred to a 70-ton (63560 kg) cold press, and a force of 20,000 lbs (9070 kg) is applied to the hot compression molding for 5 min. The sandwich is then removed from the cold press and the compression molded plaque is removed from the mold. The dumbbell test specimens (samples) are the cut from the plaque using the steel the described in FIG. 1of ASTM D 3307. The film used in the MIT test used the same procedure except that the chase is 8 mil (0.21 mm) thick and the amount of composition added to the mold is 11.25 g. The film samples used in the MIT test were ½ in (1.27 cm) wide strips cut from the compression molded film.

### Method—Melt Flow Rate (MFR)

MFR is measured in accordance with ASTM D 1238, at 372° C. using a 5 kg weight on the molten polymer.

### EXAMPLE

An aqueous dispersion of MFPTFE was prepared in accordance with the general procedure of U.S. Pat. No. 6,060,167. The MFPTFE dispersion had the following properties: 34.4% solids and 199 nm raw dispersion particle size (RDPS). Isolated and dried MFPTE had the following properties: 327° C. melting point, 74 J/g heat of fusion and 73 g/10 min melt flow rate.

An aqueous dispersion of PFA (copolymer of tetrafluoroethylene and perfluoro(propyl vinyl ether) (PPVE)) was prepared in accordance with the general procedure of U.S. Pat. No. 5,932,673. The PFA dispersion had the following properties: 27.3% solids and 204 nm raw dispersion particle size (RDPS). Isolated and dried PFA had the following properties: 4.3 wt % repeating units arising from perfluoro(propyl vinyl ether) and 95.7 wt % repeating units arising from tetrafluoroethylene, 308° C. melting point, 26 J/g heat of fusion, 14 g/10 melt flow rate, MIT flex life (8 mil film) of 173,000 cycles, and tensile strength of 3,626 psi.

Aqueous dispersions of MFPTFE and PFA were combined to form a mixed fluoropolymer aqueous dispersion. The amount of MFPTFE used was 20 wt % on a dry basis, based on the combined dry weights of MFPTFE and PFA.

The mixed fluoropolymer aqueous dispersion was then coagulated by vigorous mechanical agitation to form a solid fluoropolymer phase and an aqueous phase. The solid fluoropolymer phase was separated from the aqueous phase by filtration followed by drying in a convection air oven to form coagulated fluoropolymer. The coagulated fluoropolymer had the following properties: tensile strength of 3,622 psi, tensile modulus of 53,070 psi, MIT flex life of 8,606 cycles, melt flow rate of 13.9 g/10 min, and first heat melting points of 307.6° C. and 325.4° C.

Coagulated fluoropolymer was heated in a convection oven in dry air at 300° C. for 7 days. The resultant fluoropolymer composition had the following properties: tensile strength of 4,077 psi, tensile modulus of 63,927 psi, MIT flex life of 1,096,879 cycles, and first heat melting points of 315.9° C. and 328.5° C.

Coagulated fluoropolymer was melt mixed in an extruder as follows, The dried, coagulated fluoropolymer powder was added to a 28 mm Kombi-plast extruder (i.e., a 28 mm trilobal co-rotating twin screw extruder that pumps into a 1¼″ Egan single screw extruder). Extruder feed rate was 25 pounds of dried, coagulated fluoropolymer powder per hour as determined by volumetric feeder. The fluoropolymer was melt mixed at 225 rpm set point on the twin screw extruder and 25 rpm on the single screw extruder. The temperature in all zones of the extruders was 350° C. The residence time of the fluoropolymer in the extruders was approximately 2.5 minutes. The screw design is considered a general purpose compounding screw. The melt mixed fluoropolymer exiting the extruders was quenched in a water bath, then cut with a Jet-ro rotating cutter. The resultant fluoropolymer pellets were sparged overnight at 150° C. before subjecting to the heating step (iv) by heating a convection oven in dry air at 300° C. for 7 days. The resultant fluoropolymer composition had a single first heat melting point of 319.5° C.

1. A process for preparing a fluoropolymer composition comprising:
i) combining an aqueous dispersion of melt flowable polytetrafluoroethylene and an aqueous dispersion of melt-fabricable tetrafluoroethylenelperfluoro(alkyl vinyl ether) copolymer to form a fluoropolymer aqueous dispersion,
ii) coagulating said fluoropolymer aqueous dispersion to form a solid fluoropolymer phase and an aqueous phase,
iii) separating said solid fluoropolymer phase from said aqueous phase to form coagulated fluoropolymer, and
iv) heating said coagulated fluoropolymer at a temperature of from 280° C. to less than the highest melting point of said coagulated fluoropolymer for a period of time sufficient to increase the tensile modulus, increase the tensile strength, increase the MIT flex life, and decrease the melt flow rate of the coagulated fluoropolymer and thereby forming said fluoropolymer composition.

2. The process of claim 1 further comprising melt mixing, cooling and solidifying said coagulated fluoropolymer prior to step iv) heating to form melt mixed fluoropolymer in the solid state, and thereafter subjecting said melt mixed fluoropolymer to said step iv) heating.

3. The process of claim 1 further comprising melt mixing, cooling and solidifying said coagulated fluoropolymer prior to step iv) heating to form melt mixed fluoropolymer in the solid state, melt fabricating said melt mixed fluoropolymer into a fluoropolymer article, cooling and solidifying said fluoropolymer article, and thereafter subjecting said fluoropolymer article in the solid state to step iv) heating.

4. The process of claim 1 wherein said melt flowable polytetrafluoroethylene has a heat of crystallization of 50 J/g or greater.

5. The process of claim 1 wherein said melt flowable polytetrafluoroethylene constitutes from 15 to 50 weight percent of the combined weight on a dry basis of said melt flowable polytetrafluoroethylene and said melt fabricable tetrafluoroethylenelperfluoro(alkyl vinyl ether) copolymer.

6. The process of claim 1 wherein said heating is carried out at a temperature of at least 300° C. and for a time period of at least 7 days, and wherein said fluoropolymer composition following said heating exhibits at least one of the follm,ving:
i) a tensile modulus measured at 25° C. at least 1.2 times greater than the tensile modulus of said coagulated fluoropolymer,
ii) a tensile strength measured at 25° C. at least 1.1 times greater than the tensile strength of said coagulated fluoropolymer, and
iii) a MIT flex life measured at 25° C. at least 100 times greater than the MIT flex life of said coagulated fluoropolymer.

7. The process of claim 1, wherein said coagulated fluoropolymer has two first heat melting points, the first melting point (Tm1) in the range of 300-314° C., and the second melting point (Tm2) in the range of 320-330° C., and wherein said fluoropolymer composition has two first heat melting points, the first melting point (Tm1H) in the range of 304-318° C., and the second melting point (Tm2H) in the range of 321-330° C., wherein Tm1H is at least 4° C. greater than Tm1, and wherein Tm2H is at least is at least 1° C. greater than Tm2.

8. The process of claim 7, wherein Tm1 H is at least 6° C. greater than Tm1, and wherein Tm2H is at least is at least 1° C. greater than Tm2.

9. The process of claim 7, wherein Tm1H is at least 8° C. greater than Tm1, and wherein Tm2H is at least is at least 1° C. greater than Tm2.

10. The process of claim 7, wherein Tm1H is at least 10° C. greater than Tm1, and wherein Tm2H is at least is at least 1° C. greater than Tm2.

11. The process of claim 1, wherein said coagulated fluoropolymer has two first heat melting points, one at 308±1° C. and another at 327±1° C., and wherein said fluoropolymer composition has two first heat melting points, one at 316±1° C. and another at 328±1° C.

12. The process of claim 2, wherein said coagulated fluoropolymer has two first heat melting points, the first melting point in the range of 300-314° C., and the second melting point in the range of 320-330° C., and wherein said fluoropolymer composition has one first heat melting point greater than said first melting point but less than said second melting point.

13. The process of claim 2, wherein said coagulated fluoropolymer has two first heat melting points, one at 308±1° C. and another at 327±1° C., and wherein said fluoropolymer composition has one first heat melting point at 319±1° C.

14. The fluoropolymer article produced by the process of claim 3, wherein the said fluoropolymer article is conductor insulation, film or tubing.

15. A fluoropolymer composition comprising melt flowable polytetrafluoroethylene and melt-fabricable tetrafluoroethylenelperfluoro(alkyl vinyl ether) copolymer, said fluoropolymer composition having two first heat melting points, one at 316±1° C. and another at 328±1° C.
